(19) United States
(12) Patent Application Publication
(10) Pub. No.: US 2014/0147606 A1
(43) Pub. Date: May 29, 2014

(54) POINT BRIDGED FIBER BUNDLE

(71) Applicant: MILLIKEN & COMPANY, Spartanburg, SC (US)

(72) Inventors: Xin Li, Boiling Springs, SC (US); Ryan W. Johnson, Moore, SC (US); Padmakumar Puthillath, Greer, SC (US); Paul J. Wesson, Inman, SC (US); Philip T. Wilson, Cincinnati, OH (US)

(73) Assignee: MILLIKEN & COMPANY, Spartanburg, SC (US)

(21) Appl. No.: 14/073,179

(22) Filed: Nov. 6, 2013

Related U.S. Application Data
(60) Provisional application No. 61/730,674, filed on Nov. 28, 2012.

(51) Int. Cl. D06M 15/55; D06M 15/507; F03D 1/06; D06M 15/564

(52) U.S. Cl. CPC D06M 15/55; D06M 15/564; D06M 15/507; F03D 1/0675
USPC 428/36.1; 428/221; 442/181; 442/366; 442/304; 442/59; 416/230

(57) ABSTRACT

A point bridged fiber bundle containing a bundle of unidirectional fibers and a plurality of bridges between and connected to at least a portion of adjacent fibers within the bundle of unidirectional fibers. The bridges contain a bridge forming material, have at least a first anchoring surface and a second anchoring surface where the first anchoring surface is discontinuous with the second anchoring surface. The bridges further contain a bridging surface defined as the surface area of the bridge adjacent to the void space. Between about 10 and 100% by number of fibers in a given cross-section contain bridges to one or more adjacent fibers within the point bridged fiber bundle and the anchoring surfaces of the bridges cover less than 100% of the fiber surfaces.

### RELATED APPLICATIONS

This application claims priority to U.S. provisional application 61/730,674, filed Nov. 28, 2012, the contents of which are incorporated herein by reference in their entirety.

### FIELD OF THE INVENTION

The present invention generally relates to fiber bundles coated with an emulsion or suspension such that a point bridged fiber bundle is created.

### BACKGROUND

The use of fiber reinforced composite materials in industry has grown as a way of delivering high strength components with lower weights. Wind turbines have gained increased attention as the quest for renewable energy sources continues. Composites are used extensively in the blades of wind turbines. The quest to generate more energy from wind power has prompted technology advances which allow for increased sizes of wind turbines and new designs of wind turbine components. As the physical size and presence of wind turbines increases, so does the need to balance the cost of manufacturing the wind turbine blades and the performance of the composite materials in the wind blade.

The fatigue performance of fiber reinforced polymer composite materials is a complex phenomenon. In these material systems, fatigue damage is characterized by the initiation of damage at multiple sites, the growth of damage from these origin sites, and the interaction of the damage emanating from multiple origins. This overall process is noteworthy for its distributed nature which offers opportunities to affect the material behavior under cyclic loading.

Fatigue performance of candidate materials has an important role in the design and materials selection process. Material technologies that can enhance the fatigue performance of glass reinforced polymer composites could enable a transition from use of epoxy resin to use of vinyl ester (VE) or unsaturated polyester (UP) resins for high performance utility scale wind turbine blades. The transition from epoxy to VE or UP resins would reduce the resin cost to the wind blade manufacturer, allow use of lower cost molds and enable a significant reduction in mold cycle time through the elimination of complex post-curing processes. The use of textile-based manufacturing processes to build novel microstructural features within the composite may produce this benefit.

### BRIEF SUMMARY

A point bridged fiber bundle containing a bundle of unidirectional fibers and a plurality of bridges between and connected to at least a portion of adjacent fibers within the bundle of unidirectional fibers. The bridges contain a bridge forming material and have at least a first anchoring surface and a second anchoring surface where the first anchoring surface is discontinuous with the second anchoring surface and the first and second anchoring surfaces are in contact with two different fibers. The bridges further contain a bridging surface defined as the surface area of the bridge adjacent to the void space. Between about 10 and 100% by number of fibers in a given cross-section contain bridges to one or more adjacent fibers within the point bridged fiber bundle and the anchoring surfaces of the bridges cover less than 100% of the fiber surfaces.

### BRIEF DESCRIPTION OF THE DRAWINGS

FIG. 1 is a cross-sectional illustrative view of one embodiment of a point bridged fiber bundle.

FIG. 2 is a cross-sectional illustrative view of one embodiment of a point bridged fiber composite.

FIGS. 3 and 4 are illustrations of images of one embodiment of a point bridged fiber composite.

FIGS. 5 and 6 are diagrams showing adjacent fibers.

FIGS. 7-9 are illustrative views showing the bridging structure in one embodiment of a point bridged fiber bundle.

FIG. 10 is an illustrative view of a wind turbine.

FIGS. 11-15 are illustrative views of a turbine blade.

### DETAILED DESCRIPTION

Studies have shown the importance of fiber sizing chemistry to the fatigue performance of composite systems. In certain composite applications, the fiber sizing is applied during fiber manufacture and is intended to remain in place through fabric forming and molding operations. In these cases, the fiber sizing has several well defined functions including protecting the filaments from self-abrasion, lubricating the yarn for further processing, maintaining fiber bundle integrity, promoting fiber separation and wet-out when in contact with the resin, and bonding the fiber surface to the resin. The multifunctional aspect of this type of sizing demands inherent compromises and limitations in formulating the sizing chemistry. Working within these constraints, fiber sizing chemistry can be optimized for particular systems. However, the magnitude of fatigue performance increase measured with optimized fiber sizing has not been found to be sufficient to enable a meaningful shift in resin type (e.g. substitution of unsaturated polyester resin for epoxy resin) for a particular application.

Various previously employed technologies have been shown to improve the fatigue properties of fiber reinforced polymer composites. The type of fibers used in a composite and the properties associated with the fibers often dictate the nature of the fatigue response. Once the type of fiber to be used is defined, the most common approach to improving the fatigue properties of polymer matrix composites has been to improve the toughness of the resin (polymer matrix) itself.

Development of toughness enhanced polymers for use as resins in composites has been a theme in polymer science for decades. Using conventional metrics for neat resin systems, thermoplastics are generally considered tougher than thermosets. However, in high cycle fatigue applications, thermoset systems typically outperform thermoplastic systems due to the differences in crack initiation, crack growth, and crack interaction behavior. Moreover, thermosetting polymers remain the dominant choice in long fiber reinforced composites due to their cost and processing benefits, particularly in large structures.

Due to their use as structural materials in critical applications such as high performance aircraft, numerous material technologies for improving the toughness of thermosetting polymers have been developed. The most ubiquitous approach is to utilize a naturally tough material such as elastomers and combine the tough material with the thermosetting polymer to achieve improved toughness. Improvements on elastomer based concepts employ thermoplastics as the toughening agents which can achieve similar improvements in toughness without compromising the modulus or glass transition temperature of the polymer matrix. In order to work well, these systems require specific chemical relationships and hence concepts developed in one system such as epoxy are not necessarily compatible with other resin chemistries. For example, systems based on the solubility of the toughening phase in the resin followed by precipitation of the toughening phase into the desired morphology are very sensitive to both resin chemistry and processing conditions.

In order to develop economical approaches to enhancing relevant properties of composite materials, there is a need for targeted material architectures for improving the specific properties of interest using common materials and processes.

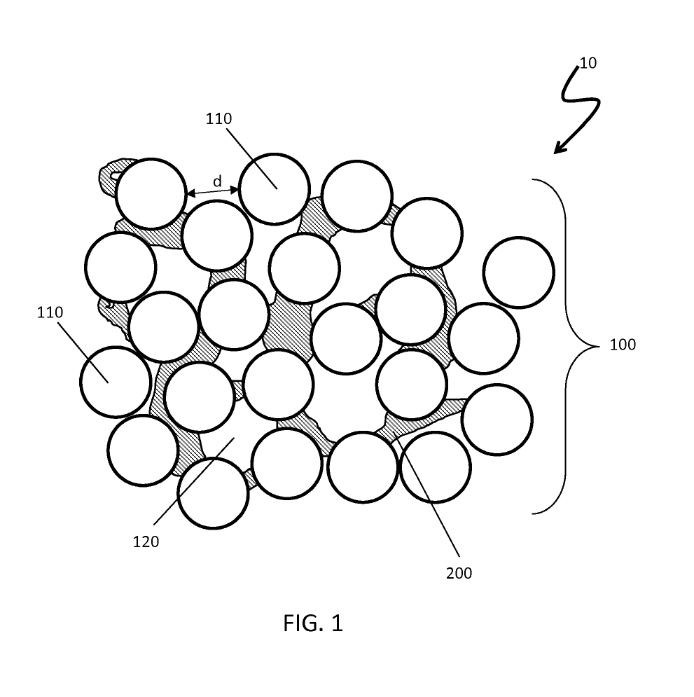

FIG. 1 is an illustration of one embodiment of a point bridged fiber bundle 10. The point bridged fiber bundle 10 contains a bundle of unidirectional fibers 100 and a bridge forming material forming a plurality of bridges between and connected to a portion of adjacent fibers. The bundle of unidirectional fibers 100 contains fibers 110 and void space 120 surrounding the fibers 110 within the bundle of unidirectional fibers 100.

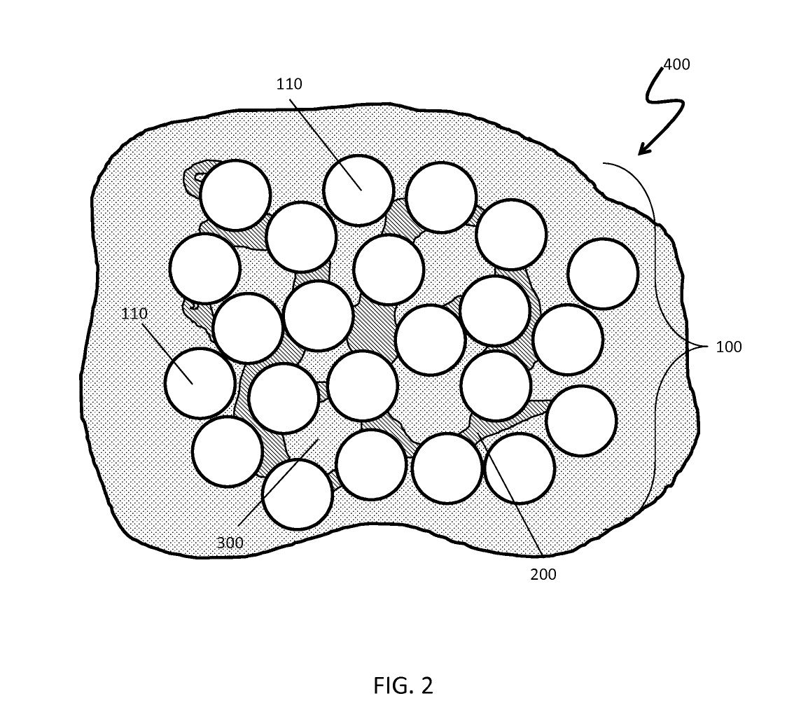

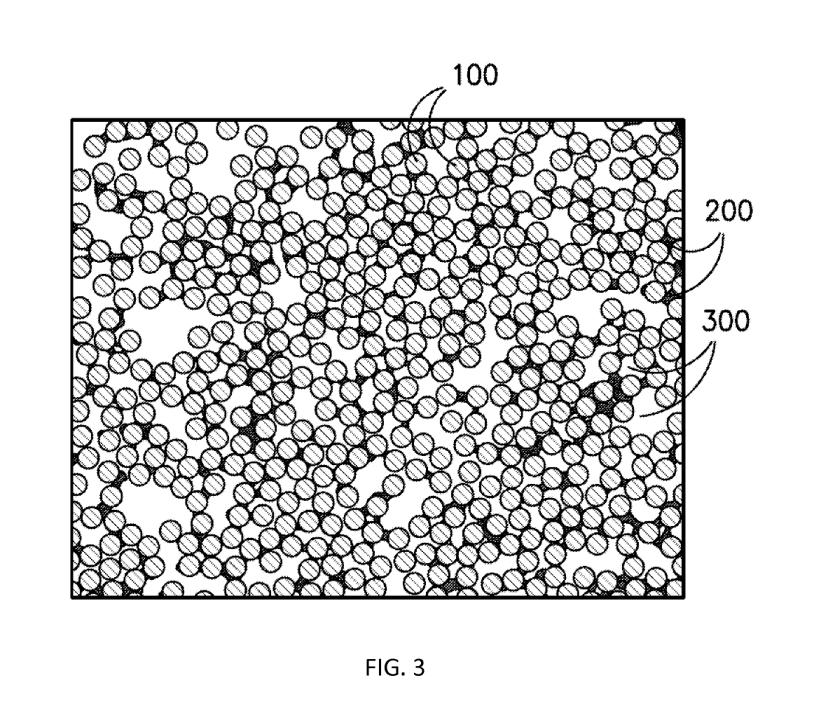

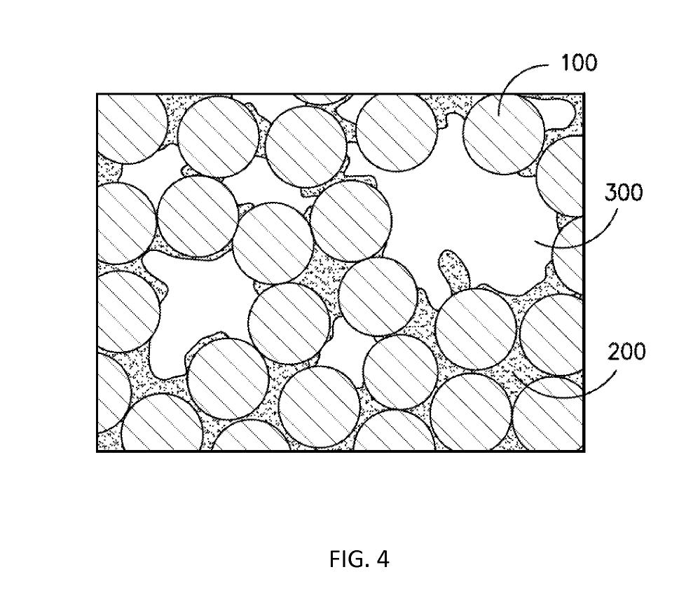

Once the point bridged fiber bundle is infused with resin and cured, a point bridged fiber composite 400 illustrated in FIG. 2 is formed. In the point bridged fiber composite, the resin 300 coats and infuses into the bundle of unidirectional fibers 100 and cures at least partially filling the void space 120 in the bundle of unidirectional fibers 100. This forms the point bridged fiber composite 400 containing a bundle of unidirectional fibers 100, a plurality of bridges 200, and resin 300. The bundle of unidirectional fibers 100 contains fibers 110 and resin 300 filling the void spaces around the bridges 200. FIGS. 3 and 4 are illustrations of actual micrograph images of one embodiment of the point bridged fiber composite taken at different magnifications.

The point bridged fiber bundle 10 (and composite 400) contain a bridge forming material which forms bridges 200 between and connected to at least a portion of the adjacent fibers. This is shown in both FIGS. 1 and 2. Preferably, between about 10 and 100% by number of fibers in a given cross-section contain bridges to one or more adjacent fibers within the fiber bundle 100. In another embodiment, between about 50 and 100% by number of fibers in a given cross-section contain bridges to one or more adjacent fibers, more preferably between about 60 and 100%, more preferably between about 75 and 100% by number of fibers in a given cross-section. The percentage of bridging may be calculated by taking a typical cross-section of the coated bundle of fibers, determining the number of fibers that are connected to at least one of their adjacent fibers by bridges divided by the total number of fibers. This bridging is formed by the bridge forming material, which extends between two adjacent fibers.

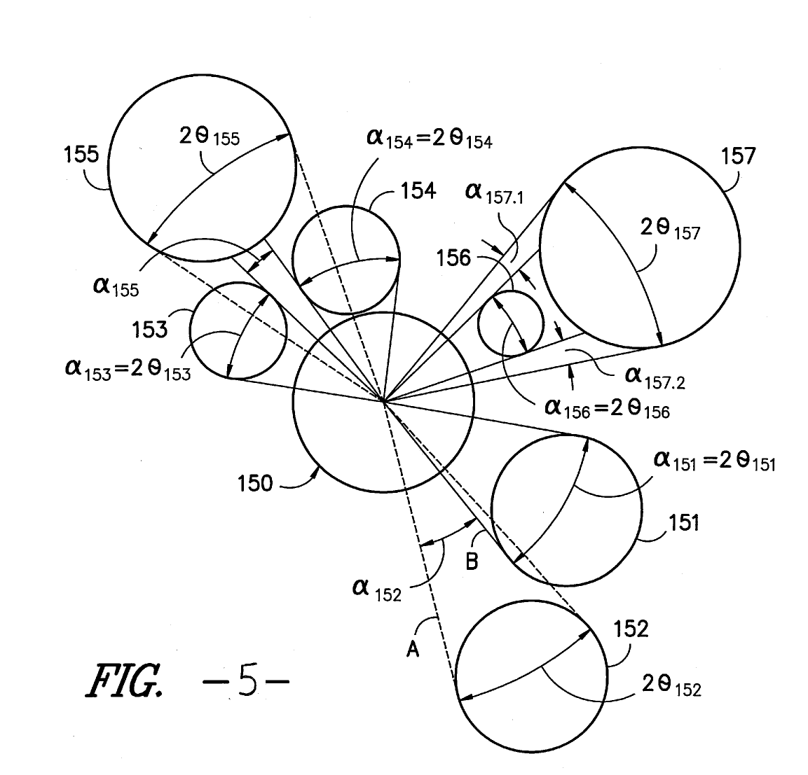

From a cross-sectional view of a fiber bundle, “adjacent fibers” are defined using the following method. Starting from the center of a specific fiber, all fibers whose centers are within 10 average fiber diameters with a significant line of sight from the center of the specified fiber are considered adjacent. A significant line of sight means that at least half of the possibly adjacent fiber is visible from the center of the specified fiber and is not covered by parts of other fibers that are closer to the specified fiber than the possibly adjacent fiber. Examples of this are shown in FIG. 5 where fiber 150 is the specified fiber. In this FIG. 5, solid tangent lines from the center of fiber 150 are drawn to fibers 151, 153, 154, and 156 and represent areas that those fibers block the view of additional fibers from the center of fiber 150, while dashed tangent lines are drawn to fibers 152, 155, and 157 to represent the full size of fibers that have a partially blocked view of fiber 150. From the center of fiber 150, all of fibers 151, 153, 154, and 156 are visible, so they are considered adjacent to fiber 150. Fiber 152 is also adjacent to fiber 150 as more than half of its surface is visible from the center of fiber 150, even though part of it is blocked by fiber 151. Fiber 155 is not adjacent to fiber 150, as more than half of its view is blocked by fibers 153 and 154. Finally fiber 157 is not adjacent to fiber 150 as more than half of its view is blocked by fiber 156.

The determination of a significant line of sight can be done either by making a geometric measurement from a cross sectional image of a fiber bundle or by doing a calculation. For example, the geometric measurement can be done on fibers 153 and 154 by first drawing lines from the center of fiber 150 that are tangent to both sides of each fiber. The angle formed by the lines that are tangent to fiber 155 defines its size (which is 2θ₁₅₅), while the visible portion is determined by the angle α₁₅₅ between the tangent lines on fibers 153 and 154. Since α₁₅₅<θ₁₅₅, fiber 155 is not adjacent to fiber 150. Similarly, tangent lines can be drawn to fibers 151 and 152. The amount of fiber 152 that is visible is then given by the angle α₁₅₂ between the tangent line A to fiber 152 and tangent line B to fiber 151. Since α₁₅₂>θ₁₅₂, fiber 152 is adjacent to fiber 150.

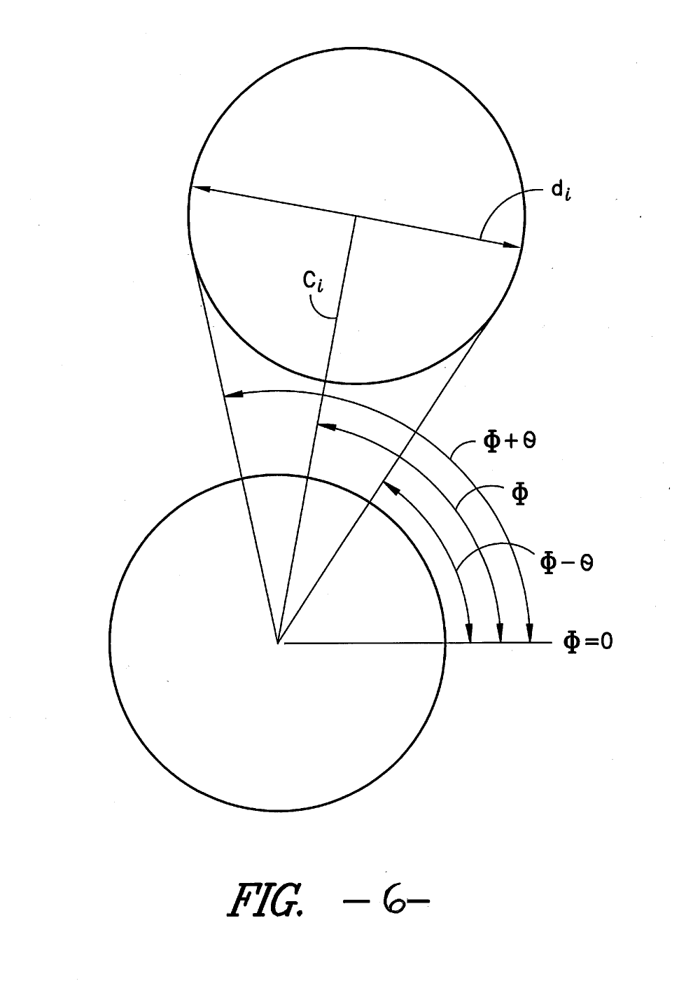

These measurements can also be done mathematically if the fibers are assumed to be cylindrical. Using polar coordinates, the position of each fiber with a diameter of dᵢ that may be adjacent to the specified fiber can be defined by a distance cᵢ between the center of the specified fiber and the center of fiber i and an angle φᵢ between the line connecting the center of the specified fiber and the center of fiber i and a reference line passing through the center of the specified fiber (see FIG. 6). The size of each fiber may then be determined as θᵢ=sin⁻¹ (dᵢ/2 cᵢ), and it blocks the region around the specified fiber from φᵢ−θᵢ to φᵢ+θᵢ. Considering the fibers in order of increasing cᵢ, the visible portion of each fiber may block a new region around the specified fiber that covers some angle αᵢ. Note that in the case of a fiber that is eclipsed by another fiber, the region may be disconnected (fibers 156 and 157), and its size measured as a sum of the angles defining the size of the individual parts. After all fibers have been considered where cᵢ is less than or equal to 10 times the average fiber diameter, only those fibers where αᵢ>θᵢ are adjacent to the specified fiber.

Within the bundle of unidirectional fibers, there are a plurality of bridges between and connected to at least a portion of adjacent fibers. The bridging between adjacent fibers helps to control the relative position of the fibers. These bridges may or may not be adhered to the surface of the fibers 110, but are preferably connected and adhered to the surface of the fibers 110. A bridge forming material that extends between at least two adjacent fibers 110 but is not attached to at least two fibers 110 is not a bridge as defined in this application. Preferably, the bridges between two (or more than two) adjacent fibers 110 are adhered to at least two of the fibers 110, more preferably adhered to more than two (or all) of the fibers 110. The bridging increases the interaction between fibers, prevents compression of the space between fibers, and still allows resin to flow between and around the agglomerated particle and fibers. Inter-fiber bridging changes the way the cracks initiate, propagate, and interact within composites.

For a small section or droplet of solid material to be considered a bridge, it must have anchoring surfaces on two or more adjacent fibers and continuously span the void space between those adjacent fibers. A bridge connecting more than two fibers may connect two or more fibers that are not adjacent to each other, as long as all fibers connected by that bridge are adjacent to one or more fibers within the bridge. Each bridge contains multiple surfaces; one or more bridging surfaces and at least two anchoring surfaces (at least a first anchoring surface and a second anchoring surface).

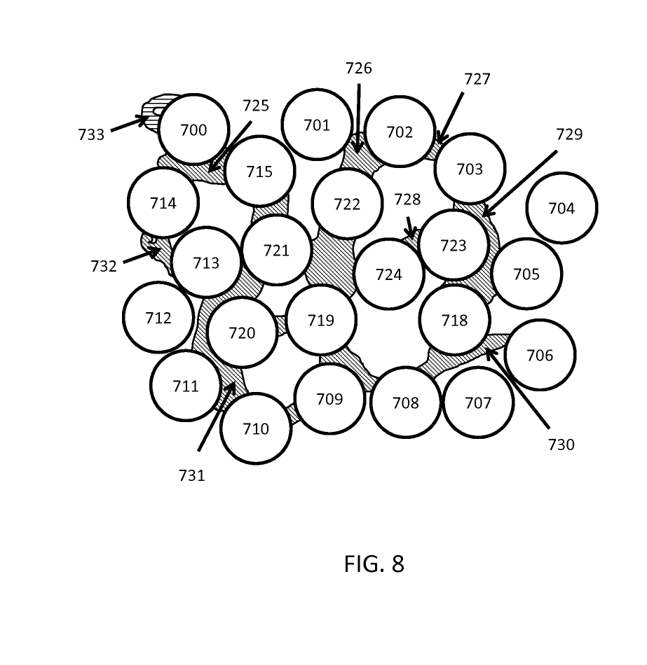

An example of bridging between fibers is shown in the illustration of FIG. 8. In this Figure, individual fibers 110 are labeled to show differences in the bridging between them. Fibers 700 through 724 are connected by a set of bridges, some of which are individually numbered from 725 to 732. In this Figure, fibers 700, 714 and 715 are connected by bridge 725. Fibers 701, 702 and 722 are connected by bridge 726. Both bridges 725 and 726 have three anchoring surfaces and three bridging surfaces. Fibers 702 and 703 are connected by bridge 727, which has two anchoring surfaces and two bridging surfaces. Fibers 723 and 724 are connected by bridge 728 which has two anchoring surfaces and one bridging surfaces. Bridges 725, 726, 727, and 728 all connect sets of fibers that are adjacent to each other, where each bridge has only one anchoring surface on a given fiber. Fibers 713 and 714 are connected by bridge 732 which has three anchoring surfaces and three bridging surfaces, and illustrates that a bridge can have multiple discontinuous anchoring surfaces on a single fiber. Fibers 703, 705, 718 and 723 are connected by bridge 729, which has four anchoring surfaces and four bridging surfaces. Fibers 706, 708 and 718 are connected by bridge 730 which has three anchoring surfaces and three bridging surfaces. Fibers 710, 711, 713, 720 and 721 are connected by bridge 731 which has five anchoring surfaces and four bridging surfaces. Within the sets of fibers connected by bridges 729, 730, and 731, all fibers within each set are not adjacent to each other, but are adjacent to at least one other fiber in the set. For example: fibers 703 and 718 are not adjacent to each other but are both adjacent to fiber 723, fibers 706 and 708 are not adjacent to each other but are both adjacent to fiber 718, and fibers 710 and 721 are not adjacent to each other but are both adjacent to fiber 720. The examples listed above are not an exhaustive list of all bridges and adjacencies within the figure, but illustrate that bridges can connect non-adjacent fibers that are mutually adjacent to another bridged fiber. The non-bridge forming material 733 has two bridging surfaces and two anchoring surfaces, but it is not a bridge as all of its anchoring surfaces are attached only to fiber 700.

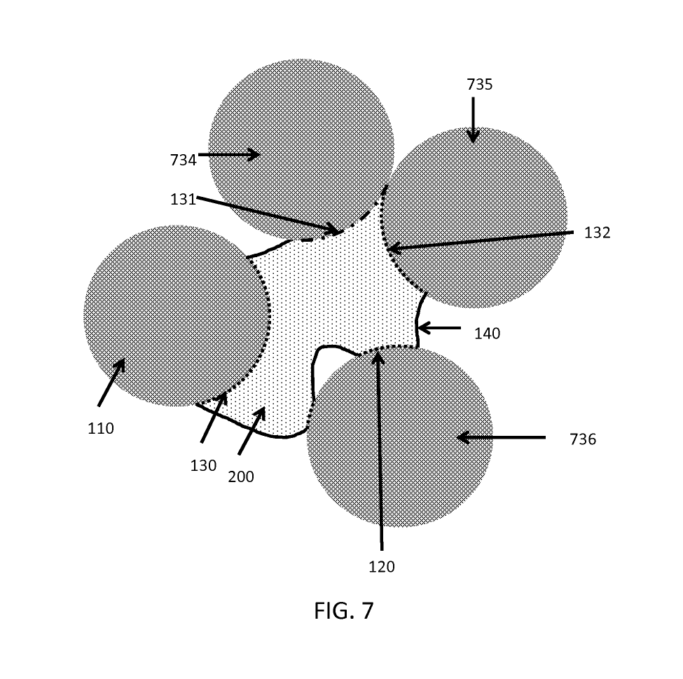

As shown in FIG. 7, an anchoring surface 130 of a bridge is defined as a continuous portion of the surface of that bridge that is adjacent to the surface of a fiber 110 that the bridge 200 is adjacent to. The contour of a particular anchoring surface closely follows the contour of the fiber that it is anchoring to, and its boundaries are defined by the continuous portion of the surface of a particular fiber that is adjacent to the bridge. Thus, if a bridge spans between two fibers that are touching tangentially, an anchoring surface is formed between the bridge and each fiber individually. This is shown in FIG. 7 with anchoring surface 131 on fiber 734 (a specific fiber 110 called out) and anchoring surface 132 on fiber 735; different styles of dashed lines are used for clarity. Likewise, if a bridge is in contact with more than one discontinuous area of the surface of a single fiber, then an equal number of discontinuous anchoring surfaces are formed between that bridge and that particular fiber, as shown on fiber 736. Each bridge has at least a first anchoring surface and a second anchoring surface, where there first anchoring surface is discontinuous with the second anchoring surface, meaning that the first and second anchoring surfaces do not overlap or intersect, however they may share an edge only if that edge is in contact with two separate fibers.

The anchoring surface may be physically or chemically bonded (through there may be in some embodiments a thin layer between anchoring surface and fiber surface, for example, a coating layer or sizing) to the surface of the fiber through interactions including but not limited to hydrogen bonding, van der Waals interactions, ionic interactions, electrostatic interactions, mechanical interlocking, or a portion of the anchoring surface may chemically react with the surface of the fiber to form covalent bonds between the fiber and the anchoring surface. The anchoring surface may be physically or chemically bonded to a coating or sizing that was previously applied to the fiber, through interactions including hydrogen bonding, van der Waals interactions, ionic interactions, electrostatic interactions, or a portion of the anchoring surface may chemically react with the coating or sizing on the surface of the fiber to form covalent bonds between the coating or sizing on the fiber surface and the anchoring surface. If the fiber or coating or sizing on the fiber is porous or if the precursors to the bridge can diffuse or penetrate into the surface of the fiber, then the anchoring surface may interpenetrate with the fiber surface on a nanometer or micrometer length scale.

Each bridge further has a bridging surface 140, defined as the surface area of the bridge 200 adjacent the void space 120 of the fiber bundle (or resin in the composite). The bridging surface can be most simply described as the surface area of a bridge 200 that is not comprised of an anchoring surface 130. The general contour of this surface will be determined by surface free energies between the continuous phase of the coating emulsion, the dispersed particles in the emulsion and the fibers; if it is energetically favorable for the emulsion to wet the fiber rather than remain as a particle in suspension, then a concave bridging surface will form between the fibers as viewed from the void space toward the bridge. The surface will often have a smooth contour, but wrinkling or buckling of the resin may occur during the crosslinking of the resin to leave an uneven bridging surface. When the point bonded fiber bundles are infused with resin to form a composite, the additional infused resin should wet both the uncovered surface of the fiber and the bridging surface.

The bridging surfaces of a bridge can be observed in a point bridged fiber bundle using microscope methods such as light microscope, scanning electron microscope (SEM), Transmission electron microscopy (TEM), Atomic force microscopy (AFM), CT-scan, and other measurements such as thermal conductivity, electrical conductivity, light scattering can also be used to confirm the existing of polymer bridges. The bridging surfaces are those that are in contact with the void space between the fibers and outside of the bridges. After the point bridged fiber bundle has been infused with a thermosetting or thermoplastic resin, the bridges and bridging surfaces may be detected by light microscopy or fluorescence microscopy if the bridges have a different color or absorbance than the surrounding resin and fibers. Different staining, etching and birefringence techniques can be used to enhance the color contrast between bridge phase and resin phase. If the colorimetric method is insufficient to make a determination, SEM elemental mapping, SEM back scattered electrons mode, or x-ray microscope may be used to detect the bridge phase and resin phase by measuring the element difference between phases. If the above methods are insufficient to make a determination, then the bridges and resin may be separated by using atomic force microscopy to measure a difference in modulus between the bridges and the surrounding polymer. If there is no difference in modulus, then the surface of the bridges may be detectable by using atomic force microscopy to measure changes in thermal conductivity, magnetic resonance imaging to detect changes in surface atomic concentrations or nano-indentation to look for slip planes.

In one embodiment, at least a number of the bridges contain a width gradient, where the width of the bridge is greatest at the anchoring surface and decreases in a gradient away from the anchoring surface. The greater width at the anchoring surface helps increase the strength of the adhesion between the bridge and the fiber, and a narrower width away from the anchoring surface leaves more void space in the fiber bundle for resin infusion. This bridge structure having a width gradient is able to be created by emulsion or suspension coating method mentioned below.

In another embodiment, in the majority of the bridges (greater than about 50% by number) the cross-sectional area the bridge is less than the total cross-sectional area of the fibers it is connected to. A smaller cross-section area of bridges leaves more void space in the fiber bundle for resin infusion. Preferably, the cross-sectional area of the bridges is less than 60% of the total cross-sectional area of the fiber it is connected to.

Where bridging occurs in the bundle of fibers 100 depends on a number of factors including but not limited to the type of bridge forming material, solvent, surface chemistry of fiber, separation distance between adjacent fibers, coating process conditions, drying conditions, post mechanical treatment during and after drying. The time required for bridging to occur also depends on concentration of bridge forming material, concentration of co-stabilizer, concentration of surfactant, surface chemistry of fiber, initial size of dispersed phase in the emulsion, temperature, solidification time of the bridge forming material, separation distance between adjacent fibers, and coating process conditions,

One factor is the separation distance “d” between adjacent fibers as shown, for example in FIG. 1. The “separation distance” in between two fibers is defined as the distance between the centers of the fibers minus the radius of each fiber. This distance can vary along the axis of the fibers but is a single value for each pair of fibers in a given cross-sectional image of a fiber bundle. As one can see in FIG. 1, there are a range of separation distances “d” between adjacent fibers. These separation distances “d” may be little to none, less than the average diameter of the fibers, greater than the average diameter of the fibers to 4 times the diameter of the fibers, or greater than 4 times the average diameter of the fibers. This separation distance “d” along with the properties of the bridge forming material affects the performance of the final product. Preferably, the majority (greater than about 50% by number) of the separation distances between adjacent fibers in the bundle of unidirectional fibers is less than about the fiber diameter. It has been shown that smaller fiber separation distances help form the point bridged structure.

It has been shown that there is a greater tendency towards bridging to occur when the separation distance “d” between two adjacent fibers is less than about the average diameter of the fibers 110. There are some important factors that control the bridge forming dynamics including capillary forces, surface energy between bridge forming material and fiber surface, surface energy between bridge forming material and continuous phase of solution surrounding it, particle stability in the emulsion, and solidification of the bridge forming material. The particle stability and gelling time help determine if the bridges form, and what size of bridges are. It is believed that when the separation distance “d” between two adjacent fibers is much larger than the average diameter of the fibers, the capillary force may not be strong enough to keep the bridging structure stable during curing of the bridge material. The surface energy between bridge forming material, continuous solution surrounding it and fiber surface may change the location and shape of the dispersed particles before they solidify, and therefore affect the coating structure. The coating process conditions can affect the space between fibers, the time window for the bridge forming material to solidify, the distribution of bridge forming material particles in the bundle of fibers, and the wet pickup during coating. The drying must be employed after the bridge forming material has solidified to form bridges among fibers instead of strictly forming a fiber surface coating. Post mechanical treatment may affect the space between fibers, the quantity of bridging in the bundle of fibers, and the bridge size.

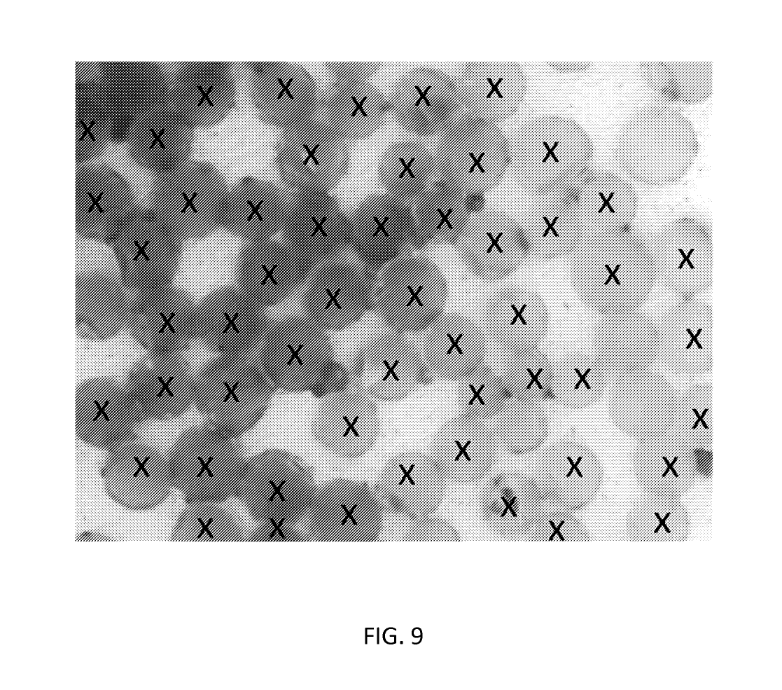

Referring to FIG. 9, all fibers with a “X” mark are considered to have bridge to adjacent fibers by definition described above. In FIG. 9, 54 fibers have the “X” mark and the total number of fibers is 61, therefore 89% by number of fibers contain bridges to one or more adjacent fibers within the polymer point bridged fiber bundle by definition.

The bridges 200 preferably form between about 0.1 and 60% of the effective cross-sectional area of the point bridged fiber bundle 10 (and point bridged fiber composite 400). In another embodiment, the bridges 200 form between about 0.1 and 30% of the effective cross-sectional area of the fiber bundle and composite, more preferably between about 0.3% and 10%, more preferably between about 0.5% and 5%. “Effective cross-sectional area”, in this application, is measured by taking a cross-sectional image of the fiber bundle and calculating the area of bridge. If the cross-sectional area of bridges is less than about 0.1%, there may not be enough bridges to enhance the mechanical properties of the composite. If the cross-sectional area of bridges is larger than 30%, there may not be enough porosity in the bundle for resin infusion leading to lower performance due to dry spots or voids in the composite systems.

The anchoring surfaces of bridges cover less than 100% of the fiber surfaces (this includes all of the surface area of the fiber). The uncovered fiber surfaces can bond to the resin directly in composites and increase the interaction between fibers and infused resin in composite. In one embodiment, the anchoring surfaces of bridges cover about 10% to 99% of the fiber surface. Preferably the anchoring surfaces of bridges cover about 30% to 90% of the fiber surface.

The bridges in the point bridged fiber bundle are formed from a bridge forming material. The bridge forming material may be any suitable material including but not limited to polymers, salts, metals, glasses, or crystals of inorganic or organic chemicals. Preferably the bridge forming material is a polymer including but not limited to thermoset resin, thermoplastic resin, ionomer, dendrimer, and mixtures thereof. Thermoset resins, such as unsaturated polyester, vinyl ester, epoxy, polyurethane, acrylic resin, and phenolic, are liquid resins which harden by a process of chemical curing, or cross-linking, which takes place during the coating process. Thermoplastic resins, such as polyethylene, polypropylene, PET and PEEK, are liquefied by the application of heat prior to coating and re-harden as they cool within the fiber bundle. Preferably, the bridge forming material has good adhesion on fiber surface. Preferably, the bridge forming material is immiscible with water in its liquid state (i.e., melt state for thermoplastic resin, uncured state for thermoset resin). In one embodiment, the bridge forming material is an unsaturated polyester, a vinyl ester, an epoxy resin, a polyurethane resin, a phenol resin, a melamine resin, a silicone resin, poly(ethylene-co-vinyl acetate) (EVA), polyolefin elastomer, thermoplastic PBT, Nylon or mixtures thereof. Epoxy is preferred due to its moderate cost, good mechanical properties, good working time, and good adhesion to fibers.

In one embodiment, the bridge forming material and the resin have different chemical compositions. Having a different chemical composition, in this application, means that materials having a different molecular composition or having the same chemicals at different ratios or concentrations. Having different chemical compositions may be able to help redistribute stress in composites. In another embodiment, the bridge forming material and the resin have the same chemical compositions. Having the same compositions may make the infusing resin wet the fiber bundle more easily.

Typically, measurements of the bundle of fibers are taken after infusion because cutting a bundle of fibers may produce a large amount of debris which can make identifying the bridges difficult. Moreover, it is difficult to obtain a straight and perpendicular cut through the fiber bundle in order to have a flat cross section to measure. It believed that the bridge structure in the point bonded fiber bundle is substantially the same as the bridge structure in the point bonded fiber composite. The reasons behind this belief include 1) the flow velocity of resin in the fiber bundles is driven by capillary forces and hence is low, so there is little chance of bridges getting washed away or moved, 2) bridges are adhered to the surface of the fibers (i.e. typically cannot be washed off), 3) bridges form to the contour of the fibers, thus, if the fibers twist in the bundle and the space between fibers changes shape the bridges will not be able to push through the tortuous path (they could possibly slide down the center of an ordered array of fibers) so they have limited mobility within the bundle 4) the size of the bridges is large relative to the separation distance between fibers, so they will have trouble getting out of a fiber bundle, 5) experiments showed that the shape of bridges does not change after it is immersed in resin in the time scale of resin curing time. This suggests that the bridges are not able to be dissolved or re-dispersed in resin.

The bundle of unidirectional fibers 100 may be any suitable bundle of fibers for the end product. “Unidirectional fibers”, in this application means that the majority of fibers aligned in one direction with the axis along the length of the fibers being generally parallel. The composite 400 may contain a single bundle of fibers or the bundle of fibers may be in a textile layer including but not limited to a woven textile, non-woven textile (such as a chopped strand mat), bonded textile, knit textile, a unidirectional textile, and a sheet of strands. In one embodiment, the bundle of unidirectional fibers 100 are formed into unidirectional strands such as rovings and may be held together by bonding, knitting a securing yarn across the rovings, or weaving a securing yarn across the rovings. In the case of woven, knit, warp knit/weft insertion, non-woven, or bonded the textile can have fibers that are disposed in a multi- (bi- or tri- or quadri-) axial direction. In one embodiment, the bundle of unidirectional fibers 100 contains an average of at least about 2 fibers, more preferably at least about 20 fibers. The fibers 110 within the bundles of fibers 100 generally are aligned and parallel, meaning that the axes along the lengths of the fibers 110 are generally aligned and parallel. Each fiber has a fiber surface defined to be the outer surface of the fiber and a fiber diameter.

In one embodiment, the textile is a woven textile, for example, plain, satin, twill, basket-weave, poplin, jacquard, and crepe weave textiles. A plain weave textile has been shown to have good abrasion and wear characteristics. A twill weave has been shown to have good properties for compound curves.

In another embodiment, the textile is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face.

In another embodiment, the textile is a multi-axial textile, such as a tri-axial textile (knit, woven, or non-woven). In another embodiment, the textile is a non-woven textile. The term non-woven refers to structures incorporating a mass of fibers that are entangled and/or heat fused so as to provide a structure with a degree of internal coherency. Non-woven textiles may be formed from many processes such as for example, meltspun processes, hydroentangeling processes, mechanically entangled processes, stitch-bonded, wet-laid, and the like.

In another preferred embodiment, the textile is a unidirectional textile and may have overlapping fiber bundles or may have gaps between the fiber bundles.

In one embodiment, the bundles of unidirectional fibers 100 are in a multi-axial knit textile. A multi-axial knit has high modulus, non-crimp fibers that can be oriented to suit a combination of property requirements and may create three dimensional structures. In another embodiment, the bundles of fibers 100 are in a single roving as in filament winding.

The bundles of fibers 100 contain fibers 110 which may be any suitable fiber for the end use. “Fiber” used herein is defined as an elongated body and includes yarns, tape elements, and the like. The fiber may have any suitable cross-section such as circular, multi-lobal, square or rectangular (tape), and oval. The fibers may be monofilament or multifilament, staple or continuous, or a mixture thereof. Preferably, the fibers have a circular cross-section which due to packing limitations intrinsically provides the void space needed to host the bridges. Preferably, the fibers 110 have an average length of at least about 3 millimeters. In another embodiment, the fiber length is at least about 100 times the fiber diameter. In another embodiment, the average fiber length is at least about 10 centimeters. In another embodiment, the average fiber length is at least about 1 meter. The fiber lengths can be sampled from a normal distribution or from a bi-, tri- or multi-modal distribution depending on how the fiber bundles and fabrics are constructed. The average lengths of fibers in each mode of the distribution can be selected from any of the fiber length ranges given in the above embodiments.

The fibers 110 can be formed from any type of fiberizable material known to those skilled in the art including fiberizable inorganic materials, fiberizable organic materials and mixtures of any of the foregoing. The inorganic and organic materials can be either man-made or naturally occurring materials. One skilled in the art will appreciate that the fiberizable inorganic and organic materials can also be polymeric materials. As used herein, the term “polymeric material” means a material formed from macromolecules composed of long chains of atoms that are linked together and that can become entangled in solution or in the solid state. As used herein, the term “fiberizable” means a material capable of being formed into a generally continuous or staple filament, fiber, strand or yarn. In one embodiment, the fibers 110 are selected from the group consisting of carbon, glass, aramid, boron, polyalkylene, quartz, polybenzimidazole, polyetheretherketone, basalt, polyphenylene sulfide, poly p-phenylene benzobisoaxazole, silicon carbide, phenolformaldehyde, phthalate and napthenoate, polyethylene. In another embodiment, the fibers are metal fibers such as steel, aluminum, or copper.

Preferably, the fibers 110 are formed from an inorganic, fiberizable glass material. Fiberizable glass materials useful in the present invention include but are not limited to those prepared from fiberizable glass compositions such as S glass, S2 glass, E glass, R glass, H glass, A glass, AR glass, C glass, D glass, ECR glass, glass filament, staple glass, T glass and zirconium oxide glass, and E-glass derivatives. As used herein, “E-glass derivatives” means glass compositions that include minor amounts of fluorine and/or boron and most preferably are fluorine-free and/or boron-free. Furthermore, as used herein, “minor amounts of fluorine” means less than 0.5 weight percent fluorine, preferably less than 0.1 weight percent fluorine, and “minor amounts of boron” means less than 5 weight percent boron, preferably less than 2 weight percent boron. Basalt and mineral wool are examples of other fiberizable glass materials useful in the present invention. Preferred glass fibers are formed from E-glass or E-glass derivatives.

The glass fibers of the present invention can be formed in any suitable method known in the art, for forming glass fibers. For example, glass fibers can be formed in a direct-melt fiber forming operation or in an indirect, or marble-melt, fiber forming operation. In a direct-melt fiber forming operation, raw materials are combined, melted and homogenized in a glass melting furnace. The molten glass moves from the furnace to a forehearth and into fiber forming apparatuses where the molten glass is attenuated into continuous glass fibers. In a marble-melt glass forming operation, pieces or marbles of glass having the final desired glass composition are preformed and fed into a bushing where they are melted and attenuated into continuous glass fibers. If a pre-melter is used, the marbles are fed first into the pre-melter, melted, and then the melted glass is fed into a fiber forming apparatus where the glass is attenuated to form continuous fibers. In the present invention, the glass fibers are preferably formed by the direct-melt fiber forming operation.

In one embodiment, when the fibers 110 are glass fibers, the fibers contain a sizing. This sizing may help processability of the glass fibers into textile layers and also helps to enhance fiber—polymer matrix interaction. In another embodiment, the fibers 110 being glass fibers do not contain a sizing. The non-sizing surface may help to simplify the coating process and give better control of particle—fiber interaction and particle agglomeration. Fiberglass fibers typically have diameters in the range of between about 10-35 microns and more typically 17-19 microns. Carbon fibers typically have diameters in the range of between about 5-10 microns and typically 7 microns, the fibers (fiberglass and carbon) are not limited to these ranges.

Non-limiting examples of suitable non-glass fiberizable inorganic materials include ceramic materials such as silicon carbide, carbon, graphite, mullite, basalt, aluminum oxide and piezoelectric ceramic materials. Non-limiting examples of suitable fiberizable organic materials include cotton, cellulose, natural rubber, flax, ramie, hemp, sisal and wool. Non-limiting examples of suitable fiberizable organic polymeric materials include those formed from polyamides (such as nylon and aramids), thermoplastic polyesters (such as polyethylene terephthalate and polybutylene terephthalate), acrylics (such as polyacrylonitriles), polyolefins, polyurethanes and vinyl polymers (such as polyvinyl alcohol).

In one embodiment, the fibers 110 preferably have a high strength to weight ratio. Preferably, the fibers 110 have strength to weight ratio of at least 0.7 GPa/g/cm³ as measured by standard fiber properties at 23° C. and a modulus of at least 69 GPa.

Textiles or other assemblies of the point bridged fiber bundle can be further processed to create composite preforms. One example would be to wrap the fiber bundles around foam strips or other shapes to create three dimensional structures. These intermediate structures can then be formed into composite structures by the addition of resin in at least a portion of the void space in the fiber bundle.

The point bridged fiber bundle can be further processed into a point bridged fiber composite as illustrated in FIG. 2 with the addition of resin in at least a portion of the void space in the fiber bundle, preferably filling up approximately all of the void space within the bundle.

The point bridged fiber bundle 10 is impregnated or infused with a resin 300 which flows, preferably under differential pressure, through the coated fiber bundle 10 at least partially filling the void space creating the point bridged fiber composite 400. The point bridged fiber composite could also be created by other wetting or composite laminating processes including but not limited to hand lay-up, filament winding, and pultrusion. Preferably, the resin flows throughout the point bridged fiber bundle 10 (and all of the other reinforcing materials such as reinforcing sheets, skins, optional stabilizing layers, and strips) and cures to form a rigid, composite 400.

It is within the scope of the present invention to use either of two general types of hardenable resin to infuse or impregnate the porous and fibrous reinforcements of the cores and skins. Thermoset resins, such as unsaturated polyester, vinyl ester, epoxy, polyurethane, acrylic resin, and phenolic, are liquid resins which harden by a process of chemical curing, or cross-linking, which takes place during the molding process. Thermoplastic resins, such as polyethylene, polypropylene, PET and PEEK, are liquefied by the application of heat prior to infusing the reinforcements and re-harden as they cool within the panel. In one embodiment, the resin 300 is an unsaturated polyester, a vinylester, an epoxy resin, a bismaleimide resin, a phenol resin, a melamine resin, a silicone resin, or thermoplastic PBT or Nylon or mixtures thereof. Unsaturated polyester is preferred due to its moderate cost, good mechanical properties, good working time, and cure characteristics.

In some commercial applications, the epoxy based resins have higher performance (fatigue, tensile strength and strain at failure) than polyester based resins, but also have a higher cost. The addition of the point bridging to the bundle of unidirectional fibers increases the performance of a composite using an unsaturated polyester resin to levels similar to the performance levels of the epoxy resin composite, but with a lower cost than the epoxy resin system.

Having the resin 300 flow throughout the point bridged fiber bundle 10 under differential pressure may be accomplished by processes such as vacuum bag molding, resin transfer molding or vacuum assisted resin transfer molding (VARTM). In VARTM molding, the components of the composite are sealed in an airtight mold commonly having one flexible mold face, and air is evacuated from the mold, which applies atmospheric pressure through the flexible face to conform the composite 400 to the mold. Catalyzed resin is drawn by the vacuum into the mold, generally through a resin distribution medium or network of channels provided on the surface of the panel, and is allowed to cure. Additional fibers or layers such as surface flow media can also be added to the composite to help facilitate the infusion of resin. A series of thick yarns such as heavy rovings or monofilaments can be spaced equally apart in one or more axis of the reinforcement to tune the resin infusion rate of the composite.

As an alternate to infusion of the point bridged fiber bundle 10 with liquid resin, the coated bundle of fibers may be further pre-impregnated (prepregged) with partially cured thermoset resins, thermoplastic resins, or intermingled with thermoplastic fibers which are subsequently cured by the application of heat.

The point bridged fiber composite 400 may be used as a structure or the composite 400 have additional processes performed to it or have additional elements added to form it into a structure. It may also be bonded to other materials to create a structure including incorporation into a sandwich panel. In one embodiment, skin sheet materials such as steel, aluminum, plywood or fiberglass reinforced polymer may be added to a surface of the composite 400. This may be achieved by adding the additional reinforcement layers while the resin cures or by adhesives. Examples of structures the composite may be (or be part of) include but are not limited to wind turbine blades, boat hulls and decks, rail cars, bridge decks, pipe, tanks, reinforced truck floors, pilings, fenders, docks, reinforced beams, retrofitted concrete structures, aircraft structures, reinforced extrusions or injection moldings or other like structural parts.

The point bridged fiber composite 400, as compared to a composite without the point bridging, typically has increased local stiffness, increased local toughness, longer crack path length, and more uniform fiber distribution within the bundles. The composites having the point bridging may also have enhanced fatigue, enhanced resistance to delamination, and enhanced impact damage tolerance. These benefits may allow for longer, lighter, more durable and/or lower cost structures in numerous applications including wind turbine blades.

One benefit of fiber bundles enhanced with point bridging is the opportunity to utilize the enhanced fiber bundles in specific subsections of the structure where the demonstrated performance benefit is most applicable.

Wind turbine blades are an example of a large composite structure that can benefit from use of point bridged fiber bundles in specific areas. The loading patterns on wind turbine blades are complex, and the structure is designed to satisfy a range of load requirements. For example, wind turbine blades are designed using at least four different design criteria. The blade must be stiff enough to not strike the turbine tower, strong enough to withstand the maximum expected wind gust loads, durable enough to tolerate hundreds of millions of cycles due to the rotation of the generator, and sufficiently resistant to buckling to avoid collapsing when flexed under the combined stress induced the blade itself and the wind loads.

FIG. 10 is a schematic of a wind turbine 1700 which contains a tower 1702, a nacelle 1704 connected to the top of the tower, and a rotor 1706 attached to the nacelle. The rotor contains a rotating hub 1708 protruding from one side of the nacelle, and wind turbine blades 1710 attached to the rotating hub.

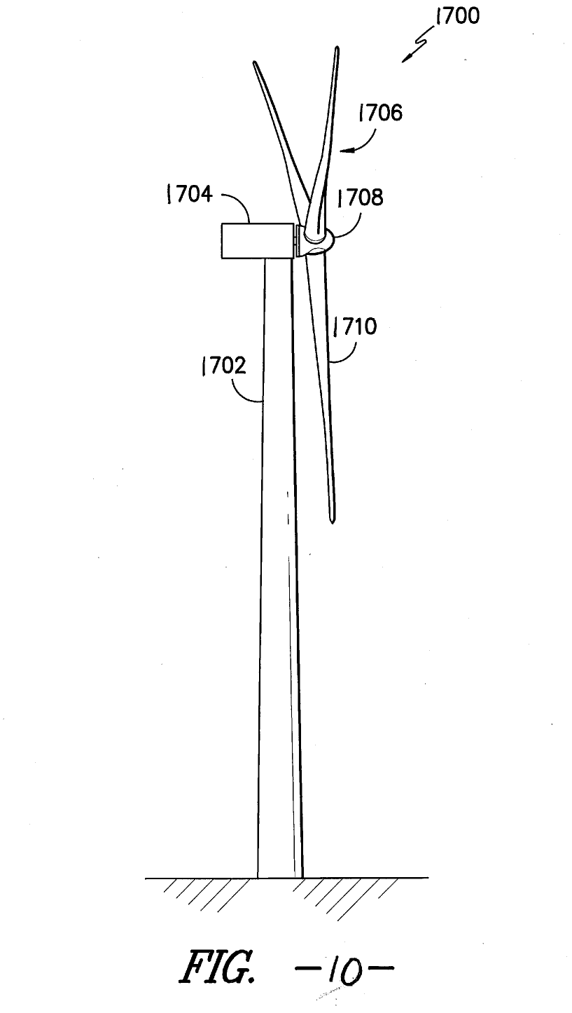

FIG. 11 is a schematic of a wind turbine blade 1710. The blade represents a type of airfoil for converting wind into mechanical motion. The airfoil 1800 extends from a root section 1802 at one end along a longitudinal axis to the tip section 1804 at the opposing end.

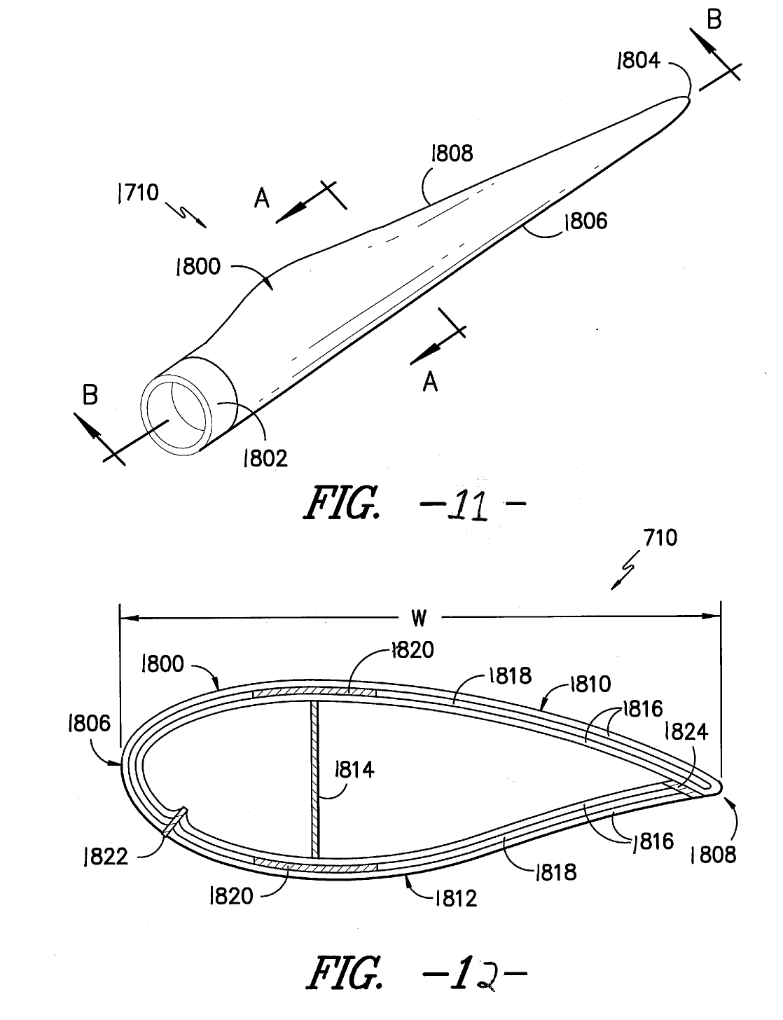

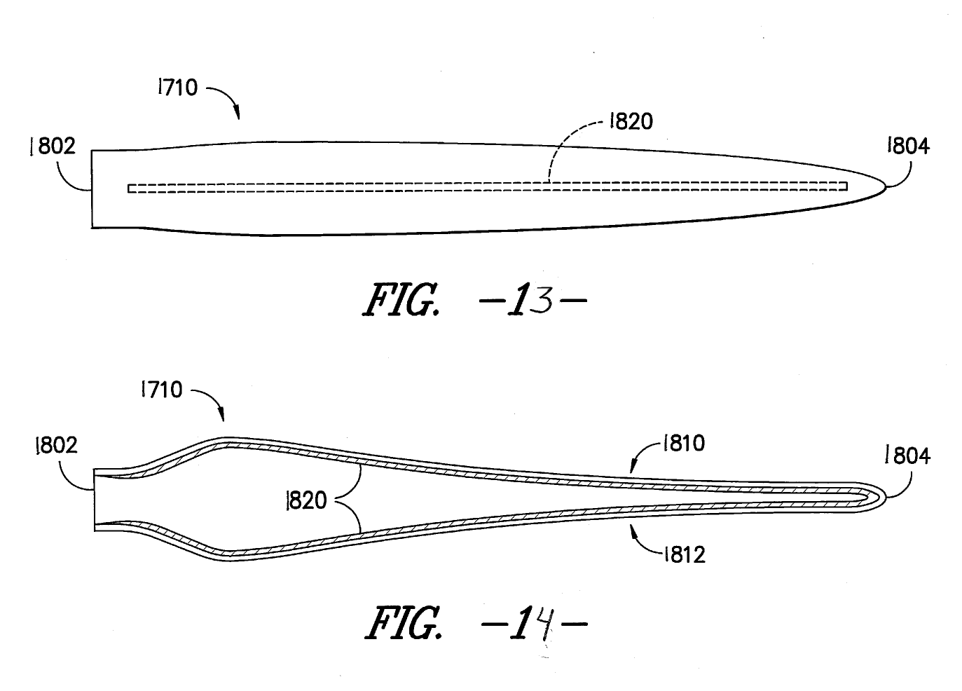

Sectional view A-A in FIG. 12 from FIG. 11 shows a typical blade cross section and identifies four functional regions around the perimeter of the wind turbine blade air foil. The leading edge 1806 and trailing edge 1808 are the regions at the ends of the line extending along the maximum chord width W. The leading and trailing edge regions are connected by two portions of a blade shell, a suction side shell 1810 and a pressure side shell 1812. The blade shells are connected via a shear web 1814 which helps stabilize the cross section of the blade during service.

The blade shells generally consist of one or more reinforcing layers 1816 and may include core materials 1818 between the reinforcing layers for increased stiffness.

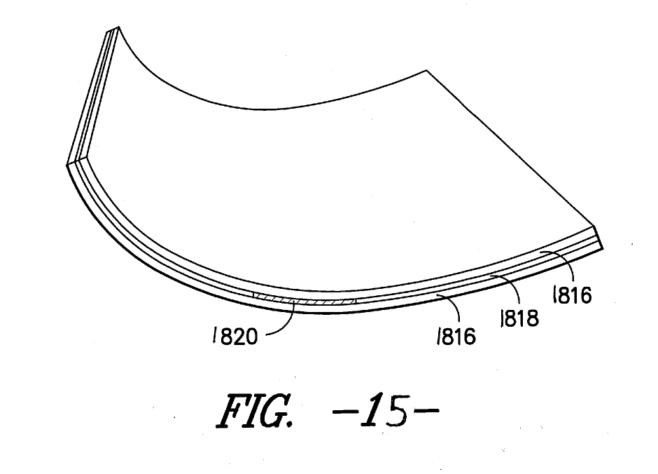

FIG. 12 also identifies two primary structural elements or spar caps 820 located within both the pressure side and suction side shell regions which both extend along the longitudinal axis of the blade as shown in FIGS. 14 and 15. FIG. 14 represents a plan view of a blade as viewed from either the pressure side or suction side of the blade while FIG. 15 is the sectional view B-B as illustrated in FIG. 11. FIG. 12 also identifies a leading edge spar 1822 structural element within the leading edge region, and an additional trailing edge spar 1824 structural element within the trailing edge region. FIG. 15 is a view along the length of the blade showing a piece of the blade shell with various layers.

During the wind turbine blade design process, different sections of the structure are optimized based on the most critical design criteria for that section. For example, in blades using fiberglass reinforced spar caps, the size of the spar caps can be based on the stiffness requirements to avoid hitting the turbine tower or the fatigue requirements over which the spar cap can be expected to remain intact over hundreds of millions of load cycles. The nature of the design process and the requirements imposed on the various sections of the blade can benefit from materials which offer the opportunity to be deployed locally within that section. A spar cap reinforcement material with improved fatigue resistance could allow more optimized wind turbine blades when fatigue performance dictates the size and weight of the spar caps.

The point bridged fiber bundle may be formed by any suitable manufacturing method. One method to form the point bridged fiber bundle begins with forming the bundle of fibers. The bundle of fibers contains a plurality of fibers and void space between the fibers. Each fiber contains a surface and the distance between the surfaces of adjacent fibers is defined as the separation distance (“d”). The bundle of fibers is then coated with an emulsion or a suspension that contains a continuous solvent phase and a dispersed phase. In one preferred embodiment the bundle of fibers is coated with an emulsion and in another embodiment, the bundle of fibers is coated with a suspension. The emulsion or suspension can be applied to the fiber bundles by any suitable coating method that results in the emulsion filling the void spaces between the fibers and wetting the surface of the fibers. The bundle of fibers is then treated to cause destabilization, agglomeration and solidification of the dispersed phase in the emulsion without allowing significant removal of either the continuous or the dispersed phase of the emulsion from the bundle of fibers. After the dispersed phase of the emulsion has solidified, the bundle of fibers is treated to remove the continuous phase and leave a point bridged fiber bundle.

The emulsion contains both a continuous solvent phase and a discontinuous dispersed liquid phase. The two phases are chosen so that the discontinuous dispersed phase is sufficiently stable that it does not agglomerate or solidify on the time scale required for emulsion preparation and coating at typical emulsion preparation and coating temperatures. This typically requires the resin to be stable for a period of at least several minutes. In one embodiment, the average size of the particles in the dispersed phase (called dispersed particles or micelles or referred to as the discontinuous phase) in the emulsion is less than 50 μm, preferably less than 10 μm. These dispersed particles make up at least about 0.5% by weight of the emulsion, more preferably at least about 1% by weight, more preferably at least about 3% by weight. In another embodiment, the emulsion contains between about 3 and 10% by weight of dispersed particles.

The continuous phase of the emulsion can contain an aqueous, a non-aqueous liquid, or a mixture of both. Preferably the solvent is aqueous or polar because of the cost and environmental concerns, wettability of the fiber, flammability issues and ability to create an emulsion with the dispersed phase. The solvent may also contain a surfactant, which may improve the stability of the dispersed phase after emulsification or may make emulsification a more reliable and efficient process.

The discontinuous phase of the emulsion contains a chemical or mixture of chemicals that is liquid when in the emulsion and can solidify when exposed to a stimulus after coating the emulsion onto the fiber bundle. When liquid, the chemicals comprising the discontinuous phase are not miscible or are sparingly soluble in the continuous phase. The chemical or mixture comprising the discontinuous phase can solidify by undergoing a chemical reaction, cooling below its melt point, precipitating, crystallizing, or evaporation of a portion of the mixture. Preferably this phase change occurs because of a chemical reaction, such as polymerization or crosslinking of mixture that may contain monomers, oligomers, cross-linkers, and initiators; these are commonly available as thermosetting resins that are paired with either a hardener or initiator. The discontinuous phase may also contain catalysts which may affect the rate of solidification of the discontinuous phase. It may also contain other solvents that affect the stability of emulsion, the rate of solidification, the structure of the resulting point bridges, or the surface of the bridges.

The emulsion can be applied to the fiber bundle through many coating methods that are typically used to apply liquids to fiber bundles or fabrics. The emulsion can be applied using dip, nip, roll, kiss transfer, spray, slot, slide, die, curtain, or knife coating processes among others. The coating should be applied so that it fills the void spaces within the fiber bundles and so that it does not destabilize the emulsion during the coating process. Mechanical action, such as passing over a series of rollers, passing over a roller with a patterned surface, pumping the emulsion through the fiber bundles, repeated saturation of the bundles with the emulsion, sonication or oscillating the fiber bundle tension may aid in homogeneously filling the void spaces between fibers within the fiber bundle. The amount of applied emulsion can be metered using routinely practiced metering methods available for the aforementioned coating methods.

After coating the bundle of fibers but before drying, the discontinuous phase is solidified in the continuous phase. This solidification process has been shown to impact the formation of the point bridge structure. An important part of the solidification process is to allow enough time for destabilization and partial coalescence of the discontinuous phase into larger bridges before it has had time to solidify. This coalescence is driven thermodynamically by the unfavorable surface free energy between the liquid discontinuous phase and the continuous phase, which will cause them to coalesce within the fiber bundle, and the favorable surface free energy interaction between the discontinuous phase and the fiber surface will cause it to wet. The rate that this coalescing will occur at depends on the concentration of discontinuous phase within the fiber bundle, the particle size of the discontinuous phase, and the viscosity of the fluids within the system. As the viscosities increase, the rate that the discontinuous phase can move within the bundle decreases.

This coalescence is terminated by the solidification occurring simultaneously within the bridging solution. The rates of these two processes, coalescence and solidification, control the size and number of bridges which means that there exists an optimal heating time and temperature cycle for each system that produces the highest performance system. When the discontinuous phase solidifies, for example when the crosslinking reaction reaches the gel point, the discontinuous phases can no longer move and are effectively trapped in their current state, leaving an inhomogeneous distribution of bridges. Were the curing to occur much slower, larger particles bridging between more fibers would be expected. The time required for the bridges to solidify can be decreased by increasing the amount of initiator, crosslinking or hardening agents. It can also be adjusted by using initiators, cross-linkers, hardening agents, or other catalysts that can affect the reactions or phase transitions occurring to solidify the bridges which are activated by external stimuli such as heat, chemical addition to the discontinuous phase, or electromagnetic radiation that can accelerate a chemical reaction such as microwave, infrared, visible, UV, or X-ray irradiation. For example, if the particles can be cross-linked using a cationic polymerization reaction, then the solidification can be accelerated by either adding an acid to the system to initiate curing by either coating it onto the fabric or including a photoacid generator within the particle and exposing it to the proper radiation to cause it to generate an acid and initiate the crosslinking. Microwave radiation has been shown to increase the reaction rate in the curing of free radical initiated epoxy systems.

Likewise, if the water is removed from the system before the discontinuous phases have cured, the discontinuous phases will want to spread out onto the functionalized glass fibers. This favorable surface interaction will cause the resin to form films on and between the fibers, greatly reducing the ability of the fabric to be infused into a composite material using standard resin infusion techniques.

The solidified discontinuous phase defines what will be the bridges within the system. The number and size of these bridges may be controlled by several factors, including the number and size of discontinuous phase particles within the fiber bundle, the rate of solidification within the bundle, the rate of particle coalescence within the bundle, evaporation of the continuous phase during solidification, the chemical composition of the fiber surface or surface coating, the composition of the continuous phase and the composition of the discontinuous phase. In general, factors that hinder the coalescence of particles before solidification, including but not limited to increased rate of solidification, decreased rate of coalescence, initially smaller emulsified particles in the emulsion, shorter fiber separation distances, and more stable emulsified particles will lead to systems that have a higher number of smaller point bridges than in systems without those perturbations.

After the discontinuous phase has solidified, the coated bundle of fibers may be dried to remove the continuous phase of the emulsion. The drying process has been shown to impact the performance of the point bridged fiber bundle in composite. To increase the production rate it is preferable to dry the fiber bundles at a temperature above room temperature, preferably at or above the boiling point of the continuous phase, provided that the drying temperature and time are below a temperature and time combination that causes the structure of the bridges to change, for example by decomposing the material forming the bridges, causing them to flow, or causing the bridges to become significantly less fatigue resistant.

In one embodiment, the coated bundle of fibers is dried at a temperature between about 80 and 150° C. for a time of between about 3 and 60 minutes. In one particular embodiment, the coated bundle of fibers is dried at temperature of 150° C. for 3 minutes. In another embodiment, the surface temperature of fiber bundles immediately after drying is at least 110° C. The energy imparted to the bundle of fibers is sufficient to remove at least 90% of the solvent by weight, preferably at least 99.7% by weight. After drying in one embodiment, the solvent content in the bundle of fibers is preferably less than 1% by weight, more preferably less than about 0.1% by weight.

Mechanical action may also be used during various steps of production. Mechanical action may be used only once in the process, or many times during different steps of the process. Mechanical action may be in the form of sonication, wrapping the bundle of fibers around a roller under tension, moving the fabric normal to its uniaxial or machine direction in the coating bath, compressing/relaxing fabric, increasing or reducing the tension of the fabric, passing it through a nip, pumping the coating liquor through the fabric, using rollers in the process with surface patterns. These surface patterns can have similar characteristic dimensions to the diameter of the fiber, the outside diameter of the fiber bundle, or the width of the fabric. It has been found that the addition of mechanical action during production of the point bridged fiber bundle may temporarily increase or decrease the space between fibers either once or multiple times, provide a pressure gradient to increase flow of the emulsion or suspension into, throughout and out of the bundle, and homogenize the distribution of dispersed resin phase within the bundle. In one embodiment, the coated bundle of fibers is subjected to mechanical action after the coating step. In another embodiment, the coated bundle of fibers is subjected to mechanical action during the drying step. In another embodiment, the coated bundle of fibers is subjected to mechanical action after the drying step. The mechanical action may help to soften the fabric and create additional discontinuity in the coating by breaking large polymer bridges into smaller pieces.

After the point bridged fiber bundle is formed, it may be further processed into a point bridged composite using the infusing the point bridged fiber bundle with resin as described previously.

### EXAMPLES

The invention will now be described with reference to the following non-limiting examples, in which all parts and percentages are by weight unless otherwise indicated.

### Fatigue Testing Method

During testing, fatigue loads are normally characterized by an R value which is defined as the ratio of minimum to maximum applied stress. By convention, compressive stress is taken to be a negative number and tension stress is taken as a positive number. Full characterization of fatigue performance involves testing over a range of R values such as R=0.1, −1, and 10, which corresponds to tension-tension, tension-compression, and compression-compression fatigue cycles respectively. Tension-tension fatigue with R=0.1 is a key metric of fatigue performance and was used to quantify the fatigue behavior of composite systems herein.

The fatigue performance of the composite materials made with the coated fiber bundles was measured using a standard tension-tension fatigue test. Dog-bone shaped test specimens were cut from composite panels using CNC cutting equipment, the preferred shape has a prismatic gage section. This feature allowed for easy measurement of strain levels in the gage section via a clip-on extensometer or strain gage.

In preparation for testing, composite tabs were adhesively bonded to the grip areas of the specimen. Optionally, strain gages were bonded to the surface of the gage section of the specimen to measure strain levels. Finally, the specimens were environmentally conditioned for 40 hours at 23° C.+/−3° C. and 50%+/−10% relative humidity.

Using a servohydraulic test machine equipped with hydraulic wedge grips, the specimens were gripped with using the minimum pressure required to avoid slipping. The machine was programmed to load the specimen in sinusoidal fashion using a specified frequency, mean load, and load amplitude. Cyclic loading continued until the specimen failed.

Typical schemes employ testing at a given R value with peak stress values chosen for the different tests of 80%, 60%, 40%, and 20% of the quasi-static strength. Test frequency is chosen to accelerate testing while ensuring the specimen temperature does not increase significantly. This means that lower stress level testing can be done at higher frequencies than higher stress level tests.

The output of a typical fatigue testing regimen at a given R value is known as an S-N curve which relates the number of cycles a material can survive to specified loading conditions. S-N curves provide the most common comparison tool for basic fatigue performance evaluation. S-N curves for well-defined conditions are frequently used to compare the fatigue performance of different composite systems under similar loading. Improvement in R=0.1 fatigue testing, generally indicates a significant change in the fatigue behavior of a composite material.

Wind blades are generally designed to withstand over 10⁸ loading and unloading cycles, however testing materials to such extremes is an impractical exercise. Comparisons are often made among materials at intermediate points such as the one million or 10⁶ cycle performance. In order to screen samples, a specific peak loading level of 1450 N/mm of specimen gage section width was applied and the number of cycles to failure was measured for each sample. This loading was chosen to balance the amount of time required to perform an experiment with the reliability of the data for predicting fatigue performance at more typical levels of strain. The loading level of 1450 N/mm was also chosen such that the epoxy control sample would withstand about 10⁵ cycles.

### Sample Layup Procedure

The typical laminate used for tensile fatigue screening was [±45/±45/₉₀0/0₉₀]s where the ±45 refers to a ply of ±45° bi-axial E-glass fabric (Devoid AMT DB 810-E05). The ₉₀0 refers to a ply of predominantly 0° unidirectional E-glass fabric with a small quantity of 90° oriented fibers and chopped fibers stitched to one side (Devoid AMT L1200/G50-E07), which was used as received for control samples and coated for other examples. The orientation of the fabric is defined by the order of the terms in the laminate specification. Overall the laminate was symmetric and contained 8 plies of fabric.

The layup procedure was to stack the layers on top of a flat glass tool prepared with a mold release and covered with one layer of release fabric (peel ply). A laser crosshair was used to provide a fixed reference for alignment of the fibers in each layer. First, two layers of ±45 fabric were placed on the tool and aligned so that the fibers ran at a 45° angle to the crosshair. Both pieces of fabric were placed so that the fibers on the top surfaces ran in the same direction. Then a ₉₀0 layer of the unidirectional fabric was aligned with the crosshair and placed with the unidirectional tows up. This was followed with a 0₉₀ layer of unidirectional fabric that was aligned and placed with the unidirectional side down. The next ₉₀0 layer of unidirectional fabric was placed with the unidirectional tows up and a final 0₉₀ layer was placed with the unidirectional tows facing down. The last two layers of ±45 fabric were placed so that the fibers on their top surface ran perpendicular to the fibers on the top surface of the ±45 fabric on the bottom two layers of the fabric stack. Finally, the laminate stack was covered with another layer of release fabric (peel ply).

The vacuum infusion molding process was used to impregnate the laminates with resin. On top of the release fabric for each laminate, a layer of flow media was used to facilitate resin flowing into the reinforcement plies. The entire laminate was covered with a vacuum bagging film which was sealed around the perimeter of the glass mold. Vacuum was applied to the laminate and air was evacuated from the system. Resin was then prepared and pulled into the reinforcement stack under vacuum until complete impregnation occurred. After the resin was cured, the composite panel was removed from the mold and placed in an oven for post-curing.

### Materials

The 0₉₀ and ₉₀0 fabric in the examples refers to Devoid AMT L1200/G50-E07 obtained from PPG. This fabric has a basis weight of 1250 gsm with unidirectional glass fiber bundles about 1150 gsm in the 0° direction (machine direction), 50 gsm fibers in a second direction (cross-machine direction), and 50 gsm chopped fibers stitch bonded to the face containing the fibers in a second direction. The face of this fabric is the exposed unidirectional glass fiber bundles and the back of this fabric is the side containing the chopped fibers. The ±45 fabric in the following examples refers to as received Devoid AMT DB 810-E05 obtained from PPG.

### Control Example 1

An unsaturated polyester control sample was made using the sample layup procedure using the 0₉₀ fabric and the ±45 fabric. The stacked textiles were infused in a standard vacuum infusion apparatus at a vacuum of less than 50 mbar with unsaturated polyester resin (Aropol Q67700 available from Ashland) and 1.5 parts per hundred resin (phr) methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of the unmodified glass reinforced unsaturated polyester composite at R=0.1 with a load of 1450 N/mm of specimen gage section width measured a lifetime of approximately 1×10⁴ cycles.

### Control Example 2

An epoxy control sample was made using the sample layup procedure using the 0₉₀ fabric and the ±45 fabric. The stacked textiles were infused in a standard vacuum infusion apparatus at a vacuum of less than 50 mbar with epoxy resin (EPIKOTE™ Resin MOS® RIMR 135 available from Momentive), 24 phr curing agent (EPIKURE™ Curing Agent MOS® RIMH 137 available from Momentive) and 6 phr curing agent (EPIKURE™ Curing Agent MOS® RIMH 134 available from Momentive). The resin flow direction was along the 0° direction of the 0₉₀ fabric. The panel was cured at room temperature more than 16 hours and further post cured at 80° C. for 24 hours. Fatigue testing of the unmodified glass reinforced epoxy resin composite at R=0.1 with a load of 1450 N/mm of specimen gage section width measured a lifetime of approximately 1×10⁵ cycles.

### Example 1

A polymer point bonded fiber bundle was formed by coating the 0₉₀ fabric in the following manner. First, a polymer emulsion was made by mixing an epoxy resin (EPON™ Resin 828 from Momentive), 24 phr hardener (Ethacure 100 from Albemarle), 1 phr hexadecane for 2 minutes. The epoxy solution was added into a 1% sodium dodecyl sulfate (SDS) solution in water at a 3% mass fraction of the epoxy solution in the SDS solution. The blends were mixed by using high shear mixer (ROSS high shear mixer, Laboratory Model, slotted stator head) with the four-blade high shear mixer rotor of the standard design within a close tolerance stator at roughly 2000 fpm (feet per min) for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and dried at 80° C. for 8 hours.

### Example 2

An unsaturated polyester test sample was made using the sample layup procedure using the coated 0₉₀ fabric from example 1 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of this modified glass reinforced unsaturated polyester composite at R=0.1 with a load of 1450 N/mm of specimen gage section width measured a lifetime approximately 75 times that of the Control Example 1.

### Example 3

A polymer point bonded fiber bundle was formed by coating the 0₉₀ fabric in the following manner. First, a polymer emulsion was made by mixing an epoxy resin (EPON™ Resin 828 from Momentive), 24 phr hardener (Ethacure 100 from Albemarle), 1 phr hexadecane and 0.3 phr red fluorescent dye (Rhodamine B from Sigma-Aldrich) for 2 minutes. The epoxy solution was added into a 1% SDS and 1% Rhodamine B solution in water at a 3% mass fraction of the epoxy solution in the SDS/Rhodamine B solution. The blends were mixed by using high shear mixer (ROSS high shear mixer, Laboratory Model, slotted stator head) with the four-blade high shear mixer rotor of the standard design within a close tolerance stator at roughly 2000 fpm for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and washed with hot water then acetone 3 times to remove excess Rhodamine B. The fiber bundles were then dried at 80° C. for 8 hours to form the red fluorescent dye stained polymer point bonded fiber bundles.

### Example 4

An unsaturated polyester test sample was made using the sample layup procedure using the coated 0₉₀ fabric from example 1 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours.

### Example 5

A polymer point bonded fiber bundle was formed by coating the 0₉₀ fabric in the following manner. First, a polymer emulsion was made by mixing an epoxy resin (EPIKOTE™ Resin MOS® RIMR 135 from Momentive), 25.5 phr hardener (Ethacure 100 from Albemarle), 1 phr hexadecane for 2 minutes. The epoxy solution was added into a 1% sodium dodecyl sulfate (SDS) solution in water at a 3% mass fraction of the epoxy solution in the SDS solution. The blends were mixed by using high shear mixer (ROSS high shear mixer, Laboratory Model, slotted stator head) with the four-blade high shear mixer rotor of the standard design within a close tolerance stator at roughly 2000 fpm for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and dried at 80° C. for 8 hours.

### Example 6

An unsaturated polyester test sample was made using the sample layup procedure using the coated 0₉₀ fabric from example 5 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of this modified glass reinforced unsaturated polyester composite at R=0.1 with a load of 1450 N/mm of specimen gage section width measured a lifetime approximately 105 times that of the Control Example 1.

### Example 7

A polymer point bonded fiber bundle was formed by coating the 0₉₀ fabric in the following manner. First, an acrylic formula two-component polymer glue (Loctite® epoxy plastic bonder from Loctite) was mixed with equal volumess of the two parts for 30 seconds. The epoxy solution was added into a 1% sodium dodecyl sulfate (SDS) solution in water at a 3% mass fraction of the epoxy solution in the SDS solution. The blends were mixed by using high shear mixer (ROSS high shear mixer, Laboratory Model, slotted stator head) with the four-blade high shear mixer rotor of the standard design within a close tolerance stator at roughly 2000 (feet per min) fpm for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and dried at 80° C. for 8 hours.

### Example 8

An unsaturated polyester test sample was made using the sample layup procedure using the coated 0₉₀ fabric from example 1 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of this modified glass reinforced unsaturated polyester composite at R=0.1 with a load of 1450 N/mm of specimen gage section width measured a lifetime approximately 60 times that of the Control Example 1.

### Example 9

A polymer point bonded fiber bundle was formed by coating the 0₉₀ fabric in the following manner. First, a polymer emulsion was made by mixing an unsaturated polyester resin (Aropol Q67700 from Ashland), and 1.5 phr methyl ethyl ketone peroxide (MEKP) for 2 minutes. The polyester solution was added into a 1% sodium dodecyl sulfate (SDS) solution in water at a 3% mass fraction of the polyester solution in the SDS solution. The blends were mixed by using high shear mixer (ROSS high shear mixer, Laboratory Model, slotted stator head) with the four-blade high shear mixer rotor of the standard design within a close tolerance stator at roughly 2000 fpm for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and dried at 80° C. for 8 hours.

### Example 10

An unsaturated polyester test sample was made using the sample layup procedure using the coated 0₉₀ fabric from example 9 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of this modified glass reinforced unsaturated polyester composite at R=0.1 with a load of 1450 N/mm of specimen gage section width measured a lifetime approximately 13 times that of the Control Example 1.

### Example 11

A polymer point bonded fiber bundle was formed by coating the 0₉₀ fabric in the following manner. First, a polymer emulsion was made by mixing a polyurethane resin (RenCast 6401-1 from Huntsman), and 400 phr hardener (Ren 6401-2 from Huntsman) for 2 minutes. The polyurethane solution was added into a 1% sodium dodecyl sulfate (SDS) solution in water at a 5% mass fraction of the polyurethane solution in the SDS solution. The blends were mixed by using high shear mixer (ROSS high shear mixer, Laboratory Model, slotted stator head) with the four-blade high shear mixer rotor of the standard design within a close tolerance stator at roughly 2000 fpm for 3 minutes to form the polymer emulsion. The 0₉₀ fabric was dipped into the polymer emulsion immediately after the emulsion was made, then soaked in the emulsion at 80° C. for at least 16 hours to cure the emulsified polymer. The bundles of fibers were removed from the polymer emulsion and dried at 80° C. for 8 hours.

### Example 12

An unsaturated polyester test sample was made using the sample layup procedure using the coated 0₉₀ fabric from example 11 and the ±45 fabric. The stacked textiles were infused in a standard vacuum infusion apparatus at a vacuum of less than 50 mbar with unsaturated polyester resin (Aropol Q67700 available from Ashland) and 1.5 phr methyl ethyl ketone peroxide (MEKP). The resin flow direction was along the 0° direction of the 0₉₀ fabric. The panel was cured at room temperature for more than 8 hours and further post cured at 80° C. for more than 4 hours. Fatigue testing of this modified glass reinforced unsaturated polyester composite at R=0.1 with a load of 1450 N/mm of specimen gage section width measured a lifetime approximately 6 times that of the Control Example 1.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A point bridged fiber bundle comprising:
a bundle of unidirectional fibers comprising a plurality of fibers and void space between the fibers, wherein the fibers comprise a fiber surface and a fiber diameter, and wherein the distance between adjacent fibers is defined as the separation distance, wherein the majority of the separation distances between adjacent fibers in the bundle of fibers are less than about the fiber diameter; and,
a plurality of bridges between and connected to at least a portion of adjacent fibers, wherein the bridges comprise a bridge forming material, wherein each bridge has at least a first anchoring surface and a second anchoring surface, the anchoring surface is defined as the surface area adjacent a fiber, wherein the first anchoring surface is discontinuous with the second anchoring surface, wherein the bridge further comprises a bridging surface defined as the surface area of the bridge adjacent to the void space,
wherein between about 10 and 100% by number of fibers in a given cross-section contain bridges to one or more adjacent fibers within the point bridged fiber bundle, and wherein the anchoring surfaces of the bridges cover less than 100% of the fiber surfaces.

2. The point bridged fiber bundle of claim 1, wherein at least a portion of the bridges comprise a width gradient, wherein the width of the bridge is greatest at the anchoring surface and decreases in a gradient away from the anchoring surface.

3. The point bridged fiber bundle of claim 1, wherein the bridges form between about 0.1 and 30% of the cross-sectional area of the point bridged fiber bundle.

4. The point bridged fiber bundle of claim 1, wherein the bundles of fibers are in a textile selected from the group consisting of a woven, non-woven, knit, and unidirectional textile.

5. The point bridged fiber bundle of claim 1, wherein the fibers comprise a material selected from the group consisting of glass, carbon, boron, silicon carbide, and basalt.

6. The point bridged fiber bundle of claim 1, wherein the bridge forming material is selected from the group consisting of epoxy, unsaturated polyester, vinyl ester, polyurethane, silicon rubber, acrylic, PVC, nylon, poly(ethylene-co-vinyl acetate), polyolefin elastomer, and mixtures thereof.

7. The point bridged fiber bundle of claim 1, wherein the bridge forming material comprises a thermoset resin.

8. The point bridged fiber bundle of claim 1, wherein the bridge forming material comprises a thermoplastic resin.

9. A point bridged coated textile comprising the point bridged fiber bundle of claim 1.

10. A point bridged fiber composite comprising:
a bundle of unidirectional fibers comprising a plurality of fibers and void space between the fibers, wherein the fibers comprise a fiber surface and a fiber diameter, and wherein the distance between adjacent fibers is defined as the separation distance, wherein the majority of the separation distances between adjacent fibers in the bundle of fibers is less than about the fiber diameter; and,
a plurality of bridges between and connected to at least a portion of adjacent fibers, wherein the bridges comprise a bridge forming material, wherein each bridge has at least a first anchoring surface and a second anchoring surface, the anchoring surface is defined as the surface area adjacent a fiber, wherein the first anchoring surface is discontinuous with the second anchoring surface, wherein the bridge further comprises a bridging surface defined as the surface area of the bridge adjacent to the void space,
a resin in at least a portion of the void space in the fiber bundle,
wherein between about 10 and 100% by number of fibers in a given cross-section contain bridges to one or more adjacent fibers within the point bridged fiber bundle, wherein the anchoring surfaces of the bridges cover less than 100% of the fiber surfaces.

11. The point bridged fiber composite of claim 10, wherein at least a portion of the bridges comprise a width gradient, wherein the width of the bridge is greatest at the anchoring surface and decreases in a gradient away from the anchoring surface.

12. The point bridged fiber composite of claim 10, wherein the bridges form between about 0.1 and 30% of the cross-sectional area of the point bridged fiber bundle.

13. The point bridged fiber composite of claim 10, wherein the fibers comprise a material selected from the group consisting of glass, carbon, boron, silicon carbide, and basalt.

14. The point bridged fiber composite of claim 10, wherein the bridge forming material is selected from the group consisting of epoxy, unsaturated polyester, vinyl ester, polyurethane, silicon rubber, acrylic, PVC, nylon , poly(ethylene-co-vinyl acetate), polyolefin elastomer, and mixture thereof.

15. The point bridged fiber composite of claim 10, wherein the bridge forming material comprises a thermoset resin.

16. The point bridged fiber composite of claim 10, wherein the bridge forming material comprises a thermoplastic resin.

17. The point bridged fiber composite of claim 10, wherein the resin is selected from the group consisting of polyester, vinyl ester, epoxy, polyurethane, acrylic, and phenolic resin.

18. The point bridged fiber composite of claim 10, wherein the bridge forming material and the resin are different polymers.

19. A structure comprising the point bridges fiber composite of claim 10.

20. The structure of claim 19, wherein the structure is selected from the group consisting of wind turbine blades, bridges, boat hulls, boat decks, rail cars, pipes, tanks, reinforced truck floors, pilings, fenders, docks, reinforced wood beams, retrofitted concrete structures, aircraft structures, reinforced extrusions and injection moldings.

21. A wind turbine blade comprising the point bridged fiber composite of claim 10.
